(19) United States
(12) Patent Application Publication
(10) Pub. No.: US 2006/0127560 A1
(43) Pub. Date: Jun. 15, 2006

(54) Protein-containing preparation which can be biotechnologically produced, method for the production thereof, and use of the same as a food ingredient

(75) Inventors: Werner Back, Freising (DE); Martin Boenisch, Muenchen (DE); Klaus Mueller, Freising (DE); Juergen Bez, Muenchen (DE); Andreas Waesche, Langenbach (DE)

Correspondence Address: FOLEY AND LARDNER LLP;SUITE 500, 3000 K STREET NW, WASHINGTON, DC, 20007, US

(73) Assignee: FRAUNHOFERGESELLSCHAFT ZUR FORDERUNG DER ANGEWANDT ANGEWANDTEN FORSCHUNG E.V.

(21) Appl. No.: 10/528,191

(22) PCT Filed: Oct. 10, 2003
(86) PCT No.: PCT/EP03/11264

§ 371 Date: Nov. 8, 2005

(30) Foreign Application Priority Data
Oct. 16, 2002 (DE) 102-48-263.2

(51) Int. Cl. A23J 1/00

(52) U.S. Cl. 426/656

(57) ABSTRACT

The invention relates to a protein-containing preparation of plant origin, having significantly improved sensoric properties and optionally also nutritional and physiological properties and undiminished good technofunctional properties. Said preparation can be obtained by fermentation with a lactic acid bacterium and is suitable as a versatile food ingredient. It contains at least 60% of protein of plant origin, in relation to the dry weight, a lacteous aroma corresponding to a quantity of at least 1 ppm diacetyl, and lactic acid. The invention also relates to a method for producing one such protein preparation, whereby a plant starting material containing at least 60 wt. % of plant protein, in relation to the dry weight of the material, is fermented in a manner known per se with a micro-organism producing a lactic acid in the presence of at least one nutrient source, nitrogen source and/or mineral source required for the micro-organism.

The present invention relates to a proteinaceous preparation of plant origin having significantly improved sensory properties and, if appropriate, also nutritional properties, and also no less good technofunctional properties, which preparation can be produced by fermentation using a lactic acid bacterium. This preparation is suitable as a food ingredient which can be used in a versatile manner.

Proteins and proteinaceous preparations are used as ingredients for the food industry and feed industry and are used in a versatile manner in the formulation of foods (meat and sausage products, bakery products, delicatessen products, drinks, ice cream and many more). The great importance of protein products is firstly in supplying humans with essential amino acids. Furthermore, proteinaceous preparations offer versatile uses, since, on account of their technical properties (“technofunctionality”), they can also be used to improve or control a multiplicity of properties such as water- or oil-binding, foam formation, texturizing, dispersibility, viscosity control or emulsibility or the like.

Depending on the type, mode of production and origin, proteinaceous preparations have differing property characteristics with respect to the technofunctional action in formulas, but also with respect to their sensory effects.

Frequently, the service concentration of plant protein preparations diverges in favor of protein preparations of animal origin (gelatin, milk protein, milk powder, whey powder), because plant protein preparations have origin-specific accompanying substances which, from the nutritional aspect, are unwanted and/or adversely affect the sensory and organoleptic impression of the formula. This is because protein preparations of plant origin are generally accompanied by off-odors, which can be described as “beany” and are apparently due to aldehydes such as hexanal, and they usually comprise antinutritional substances such as trypsin inhibitors and/or indigestible materials, for example α-1,6-glycosidically linked carbohydrates which can cause flatulence (see P. Scalabrini et al., Int. J. of Food Microbiology 39, 213-219 (1998)).

It is known that the sensory impression and nutritional value of protein preparations can be modified and improved by a biotechnological treatment of these preparations. For example, it is known that the proportion of antinutritional or indigestible substances in protein preparations from soybeans may be reduced by fermentation. As was found by H. L. Wang et al. in J. Milk Food Technol. 37, 71 (1974), Lactobacillus acidophilus grows in soymilk without addition of sugar. The lactobacilli therefore convert the α-glycosidically linked carbohydrates which are present there as exclusive energy source. Matteuzzi et al., Int. J. of Food Microbiol., 39 (1998), 213-219, and H. L. Wang (loc. cit.) found that bifidobacterium strains can break down unwanted aroma components which are formed from the oxidative breakdown of unsaturated fatty acids by lipoxygenase activity. E. R. Bucker et al., in Journal of Food Science, 44, 1534 (1979), describe the fermentation of peanut milk using 19 different lactic acid bacteria with production of lactic acid. L. R. Beuchat et al., Journal of Food Science, 43, 1109 (1978) found that the sensory properties of a milk fermented in this manner are less unpleasant so that they can compete with buttermilk in bakery products in further processing. However, the sensory properties were only rated indirectly, since bakery items solely admixed with fruit aromas were tested. L. Camacho et al. studied, in Int. J. of Food Microbiology 14, 277-286 (1991) the fermentation of a lupine bean extract by different microorganisms of the genus Lactobacillus and effect thereof on the content of alkaloids, lactoflavin and some amino acids and thus on the nutritional value of the resultant lupine milk. L. Ankenman Granata et al., J. of Food Science 61, 33 (1996) observed that keynote aroma substances such as diacetyl could be found in fermented soymilk products in comparable concentrations as in a control of (animal) milk when caseinate, casein hydrolysate and whey protein hydrolysate had been added to these products.

The starting point for the biotechnological treatment of protein preparations from suitable plant (parts) is generally a “milk” produced by extraction of the whole plant (parts), for example the seeds or beans. In this case, customarily, the starting materials are swollen in water, if appropriate pretreated, for example with sodium bicarbonate, if appropriate blanched and/or ground and then extracted. The resultant milk is filtered and then pasteurized or boiled. For soymilk, frequently, a variant of what is termed the Illinois process is employed (see, for example, A. I. Nelson et al., J. of Food Science 41 (1976), 57 or K. M. Kamaly, Food Research Int., 30 (1997), 675-682. Likewise, descriptions are given of production examples which, from lupine milk or soymilk, with the aid of suitable lactic acid bacteria produce a yogurt-like product in biotechnological processes. In this case, in addition to the nutritional and sensory properties, especially the Theological properties of the biotechnological product play a decisive role (see R. Pinthong et al., J. Fd Technol. 15 (1980), 647-652). The soymilk is fermented according to Pinthong, loc. cit., using lactic acid bacteria/yogurt starter cultures (Lactobacillus bulgaricus, Streptococcus thermophilus). In fermented soymilk this produces off-odors which can be traced to lipoxygenase activity and the release of keynote substances for rancidity. Y. J. Cheng et al., in contrast, found, in Journal of Food Science, 55 (1990), 1178, that a product which is formed by fermentation of soymilk with addition of lactose and milk proteins and yogurt starter cultures (“sogurt”), is acceptable Theologically and in sensory terms. Further literature was cited in which in part the good technical and sensory properties of the milk-like products are praised, and in part their lackings are criticized. The sensory rating is based here generally on subjective tests.

It is an object of the present invention to provide a proteinaceous preparation from plant materials which has been altered in such a manner that it reliably has beneficial taste and odor properties which are otherwise assigned to milk products, and the technical properties of which, such as emulsifying activity, gel formation and foam formation properties, have not been impaired, or have not been significantly impaired, compared with those of the starting material.

Surprisingly, it has been found that such a preparation can be obtained when plant starting materials, the protein content of which, based on the dry matter, is at least 60% by weight, more preferably at least 70% by weight, still more preferably at least 80% by weight, and maximally 100% by weight, preferably 99% by weight, more preferably 90 to 95% by weight, are biotechnologically treated, in particular when they are fermented using microorganisms producing lactic acid.

The term “protein content” as used in the present application is defined as the content which is calculated from the nitrogen determination and its multiplication by the factor 6.25.

The biotechnological treatment (fermentation) of the starting materials produces lactic acid, and therefore the inventive proteinaceous preparation comprises lactic acid. Depending on the type of lactic acid bacteria used, this is D-lactic acid, L-lactic acid, or a mixture of the two optical variants. The levorotatory L-lactic acid is known to be particularly valuable nutritionally, and therefore it is preferred that a large part, or all, of the lactic acid is present as L-lactic acid. Furthermore, it is desirable that the inventive protein preparation comprises a relatively large amount of lactic acid, that is to say preferably at least approximately 5 g/l, and more preferably at least approximately 8 g/l. In particularly favorable circumstances, even 10 g/l of lactic acid or still more can be obtained, as explained in more detail hereinafter.

Furthermore, the inventive proteinaceous preparation is characterized by a milk-product-like aroma. The aroma is produced by the fermentation. A keynote substance of this aroma is diacetyl, and in many cases a high diacetyl content is desirable, in particular if the protein preparation is to be used as ingredient in food preparations, because the flavor and odor in these cases, despite the dilution by further constituents, is to remain perceptible. The perception threshold of diacetyl is about 0.1 ppm, and the diacetyl content in the inventive product should generally be not significantly below 1 ppm. Particular preference is given to approximately 10-20 ppm, and in some cases it is possible to increase it still further.

As already mentioned hereinbefore, the inventive proteinaceous preparation is obtained from a plant starting material of high protein content on a dry basis. This content can be present in a natural manner, or else the plant starting material is pretreated to achieve this content. For example, suitable plant starting materials are high-protein plant extracts, as are obtainable, in particular, from lupines, peanuts, soybeans, peas and other legumes. Familiar examples are, as are known from the above-described prior art, aqueous plant extracts, the dry matter of which consists of about one third fat, one third protein and one third carbohydrates. In contrast thereto, the invention starts from significantly higher protein proportions in the dry matter, and this leads surprisingly to the effect that in the fermented product, a “beany” off-odor is present by objective means either not at all or only in significantly decreased amount, and in the latter case is masked so greatly by the aromas which can be characterized as “milk-product-like” that it is not perceived subjectively.

The finding that the technofunctional properties of the inventive proteinaceous preparation are comparable to those of the respectively chosen starting materials was likewise surprising, that is to say, despite the fermentation, no impairment of these properties was observable. This ensures good emulsifying properties and foam-formation properties, as are required for many applications.

The inventive proteinaceous preparation is generally completely or essentially lactose-free, since the starting materials are generally lactose-free. In most cases, there will also be no occasion to add lactose to it, although this is possible without further problems in specific cases. Furthermore, it is generally completely or essentially cholesterol-free, because the plant starting materials, in contrast to corresponding animal materials, in general comprise no cholesterol. And, of course, it is generally free of animal protein or other animal constituents, unless these are added for specific purposes.

The protein content of the inventive protein preparation is essentially unchanged compared with the starting material used.

The inventive proteinaceous preparation can, as desired, be pasteurized or sterilized in other ways, that is a prebiotic, or it can comprise further living microorganisms, that is to say a biologically active probiotic food or such an ingredient for foods. A probiotic food is preferably set to a content of 10⁶ to 10¹², more preferably of about 10⁸ to 10¹⁰, and in particular about 10⁹, microorganisms per gram of food, if this content is not already provided.

The preparation can be obtained as protein solution or protein dispersion and can then be used either in liquid or dried form (for example spray dried or dried by convection in a comparable manner). Surprisingly, it has been observed that even in dried products the milk-product-like aroma is retained.

The inventive proteinaceous preparation is suitable, for example, as food ingredient in
plant-based yogurt-like products
yogurt
plant-based milk-like drinks having 0.1-3.5% fat
aromatized milk drinks
ice cream having milk-product-like aroma
lactose-free ice cream having milk-product-like aroma
desserts
rice products (lactose-free) having milk-product-like aroma
baking aids
fine bakery products

Production of the inventive proteinaceous preparation starts with raw material preparation. Generally production starts from legumes as plant starting materials, because these are cultivated to a wide extent and are suitable on account of an acceptable protein content. However, it should be clear that the invention is not restricted to protein preparations of legumes.

As already mentioned, if needed, the protein content of dry mass is increased if this is not sufficiently high in the raw material. Thus, for example, in the raw material preparation, a deoiling (for example using a lipophilic solvent such as hexane or using CO₂) can take place. Moreover, if required, carbohydrates can be separated off. Further steps as are known from the prior art can of course likewise be provided, for example if appropriate a debittering of the starting materials or the like. An expedient starting material is, for example, that which is obtained by treating lupine seeds according to EP 1 024 706 B1. Lupine seeds naturally comprise about 38-50% protein of dry mass and thus somewhat more than, for example, soybean or even rapeseed. Using the treatment method described in said EP patent, very pure protein isolates can be obtained. Such very pure materials, also from other plant protein sources, are very highly suitable according to the invention; however, it should be clear that although such a high degree of protein purity is particularly expedient for the present invention, it is not a precondition. It can be sufficient, for example, to deoil the plant parts used and, if appropriate, free them from enzymatic activity which could have an adverse effect, and/or to debitter them. Whether the plant starting material for the fermentation is to comprise a smaller amount of mono-, oligo- and/or polysaccharides or not, will be decided by those skilled in the art considering the sought-after application.

The raw material is converted in the raw material preparation into a form suitable for the fermentation, for example into an aqueous suspension or solution. Those skilled in the art know the process steps necessary for this such as comminution of the plant starting material, extraction, separation of protein extract and fiber fraction, protein precipitation, drying and the like and will use them in the required scope, for example in recourse to the above-mentioned EP 1 024 706 B1.

Depending on composition of the suspension or solution to be fermented, as required or desired, additives must or can be added to this suspension or solution. For instance, it is necessary to take care that a sufficient amount of sugar (for example glucose) is present which serves as nutrient source for the fermenting microorganisms, and this sugar must or can if appropriate be added, or additives must or can be added which, during the fermentation, release such sugars from carbohydrates present. Furthermore, a suitable nitrogen source must be available for the micro-organisms. If the suspension or solution to be fermented cannot offer these in a sufficient amount, for example via amino acids present, corresponding nitrogenous compounds or additives which release such compounds from the material present must be added, as is known in the prior art. A suitable nitrogen source is, for example, a yeast extract. The same applies to the mineral salts, the presence of which is required for the metabolic activity of the microorganisms. They can also be added if appropriate.

The fermentation is carried out in a manner known per se using microorganisms which produce lactic acid. The fermentation can be performed anaerobically or in the presence of oxygen, homofermentatively or hetero-fermentatively. Accordingly, there is in principle no restriction in the choice of bacteria, provided that they can produce lactic acid and diacetyl and are not toxic. For instance, lactococci such as Lactococcus lactis or lacto-bacilli such as Lactobacillus casei can be used, both of which produce L-lactic acid, or other bacteria such as Pediococcus damnosus, the use of which produces a lactic acid racemate. It is particularly expedient to use for the fermentation those bacteria which produce either pure L-lactic acid and/or are able to produce a large amount of lactic acid rapidly. It has proved that, from this aspect, in particular lactobacilli of the strains Lactobacillus perolens, Lactobacillus paracasei or Lactobacillus plantarum are suitable. Lactobacillus perolens is a microorganism isolated in 1985 by Back from lemonade, inter alia deposited at the German Collection of Microorganisms and Cell Cultures GmbH (DSMZ) in Brunswick, Germany under the No. 12744. The organism was deposited by Prof. Dr. Werner Back on Oct. 23, 2002 at the DSMZ under the No. DSM 15255 under the Budapest Treaty. The address of the DSMZ is: D-38124 Braunschweig; Mascheroder Weg 1b. The other microorganisms, Lactobacillus paracasei and Lactobacillus plantarum have long been known and can be obtained commercially, for example from the DSZM in Brunswick, Germany. Examples of strains deposited there are, for example, DSZM 5622, 2649, 5457, 8741, 8742, 20006, 20020, 20207, 20244, 20312 or 46331.

To produce the fermentation medium, conventional methods can be used. For instance, the ingredients, except for glucose, are mixed and, if appropriate diluted with water, for example by introducing the mixture into water which has previously been charged into the fermenter. To prevent the growth of foreign microorganisms, suitable measures are to be taken, for example a pasteurization or Tyndallization of the fermentation medium. Suitably, then, after the heating step, a carbon source which is utilizable by the organism selected, for example glucose, can be added to the nutrient medium. This prevents browning reactions in the fermentation medium. The fermenter is then inoculated with the inoculum of the correspondingly chosen micro-organism. A suitable inoculum is, for example, an approximately 1% strength bacterial suspension. Alternatively, the microorganisms can of course also be used immobilized on a stationary substrate. The fermentation can be performed batchwise or continuously; the measures which are suitable for this are known to those skilled in the art, they do not deviate from conventional measures. The fermentation is performed at a temperature suitable for the bacterium selected. The contact with the fermentation medium can last for some hours, if appropriate also some days, depending on how rapidly the microorganism produces lactic acid. The decreasing pH can, if appropriate, be buffered, to keep the medium for as long as possible in a pH range in which further lactic acid is produced. By this measure the lactic acid production can be increased to significantly above 10 g/l.

In a preferred embodiment of the invention, fruit acid, preferably citric acid, is added to the fermentation medium. This can increase the amount of diacetyl. The inventors, in the case of this influence on the fermentation, have been able to observe, in particular in the case of citric acid, a linear correlation between the amount of fruit acid added and diacetyl formed. An amount of approximately 2 g/l of citric acid has proved to be expedient. The course of the fermentation is not adversely affected by this.

The end product obtained is a solution or a suspension which, depending on the concentration of the solution or suspension of the raw material used generally comprises about 5 to 25% dry matter, preferably about 15 to 20% dry matter. The diacetyl content is generally about 9 to 21 ppm. Antinutritional α-glycosidically linked carbohydrates are usually not present or are virtually not present.

Technologically important parameters of the inventive protein preparation can readily be set in a suitable manner. For instance, in a 1% strength solution of the inventive protein preparation (approximately 85% protein DM; starting material approximately 95% protein DM), produced according to the above-described method, an emulsifying ability (emulsifying capacity) at pH 7 in the range of 400 to over 500 ml of oil/g of protein was observed, and in a 10% strength solution an emulsifying activity of 40-50% was observed, with the control group (identical starting material, not fermented) under the same conditions being able to emulsify 500 ml of oil/g of protein. The test conditions for the emulsifying ability (emulsifying capacity) provide: 1) production of the protein dispersion/solution, 2) continuous addition of vegetable oil with agitation and emulsification of the mixture (O/W) using a laboratory reactor (IKA LR-A1000 with UltraTurrax T25 at 11 000 rpm) and rating the maximum volume of oil in ml to phase inversion (=emulsifying capacity). Commercially conventional milk protein (Na caseinate), under comparable test conditions, has an emulsifying capacity of 800-900 ml of oil/g of protein. The test conditions for the emulsifying activity provide: 1) production of the protein dispersion/solution, 2) mixing vegetable oil and this solution in the ratio of 1:1, 3) agitation and emulsification of the mixture using a laboratory agitator and 4) centrifugation of the mixture/emulsion (3000×g and 5 min.) and rating the volume of emulsion phase in percent (=emulsifying activity). Commercially conventional milk protein (Na caseinate), under comparable test conditions, has an emulsifying activity of 90%.

In the case of the inventive protein preparations having a solids content of 8 to 20%, the ability to form gels having measurable strength can be observed at pH 7 and after a 30 minute heat treatment at 90° C. and 3-hour storage at 3° C. For this, the measuring instrument used was Stable Micro Systems, TAX-T2, Surrey, GB.

At pH 7, the foam activity of the inventive protein preparations was at least 600%, and preferably greater than 1000%, for a foam density of 190 to 250 g/l. For comparison: the untreated starting material had a foam activity of 900 to 1200% and a foam density of 150 to 200 g/l. The whipping machine used was a Hobart 50-N. Hens' egg white powder having 12.6% dry matter content in solution has, under the same test conditions, after 4 minutes, a foam activity of 1500% and a foam density of 70 g/l.

The inventive protein preparation can be used either as such or else as food ingredient. Possibilities for this are listed above. The use in ice cream and the advantageous properties which are achieved thereby are specified in example 7.

The invention is to be described in more detail hereinafter with reference to example embodiments.

### EXAMPLE 1

Raw Material Preparation

Lupine seeds were husked and flocked and then deoiled and debittered in accordance with EP 1 024 706 B1. At a pH roughly corresponding to the isoelectric point, anti-nutritional substances such as soluble carbohydrates were separated off. The protein of the pretreated material was extracted by exposing it to an alkaline medium (pH 7-9) of 35° C. to 45° C., in which case a fractionation between raffinate and protein extracts was performed. From the protein extract, protein precipitation was carried out in the acidic medium (pH 4.5). The resultant “protein curd” was thermally treated and subjected to spray drying. The resultant protein isolate had the following composition (% by weight):
Water 5-7
Dry matter 92-93
Crude protein content (in dry matter)>90%
Fat content (in dry matter)<2.5%
Carbohydrates (in dry matter)<1%.

### EXAMPLE 2

Anaerobic Fermentation Using Lactobacillus Perolens

The protein isolate from example 1 was mixed with yeast extract, mineral salt and citric acid (composition: 15% protein isolate, 0.5% yeast extract, 0.5% mineral salts, 0.2% citric acid) and dispersed in previously sterilized water which had already been charged into the fermenter. Tyndallization of the fermentation medium was then performed:

1. Pasteurization at 72° C. for 10 min

2. Incubation of the medium for 24 h at 30° C.

3. Pasteurization at 82° C. for 10 min

After the end of the 2nd pasteurization step, D(+)-glucose monohydrate was added in an amount of 2% by weight, which was shifted to this time point to prevent browning reactions in the fermenter. Then, the fermenter was inoculated with the inoculum of the microorganism (1% bacterial suspension based on the fermenter contents). The mixture was allowed to ferment anaerobically at 27° C. for 48 hours.

As online measured parameters, the following were determined: pH, temperature, speed of rotation of the fermenter, dissolved oxygen. As analytical measured parameters, the bacterial count, the amount of diacetyl as keynote aroma substance and the lactic acid concentration were determined.

After 48 h, the fermentation was ended by pasteurization of the medium at 72° C. for 10 minutes.

Fermentation medium content after 48 h fermentation:
L(+)-lactic acid 17.5 g/l; pH 4.1
Diacetyl 11.5 ppm

The example was repeated using altered amounts of citric acid (0 g/5 g), in which case it was observed that the diacetyl formation was linearly correlated with the amount of citric acid and does not adversely affect the course of the fermentation. If no citric acid was added, a diacetyl concentration lower by about the factor 1.5-2 was detected in the end product.

### EXAMPLE 3

Anaerobic Fermentation Using Lactobacillus Perolens

Example 2 was repeated with the proviso that the fermentation was carried out under aerobic conditions with 15% oxygen saturation under otherwise unchanged conditions.

Fermentation medium content after 48 h fermentation:
L(+)-lactic acid 17.5 g/l; pH 4.2
Diacetyl 21.9 ppm

### EXAMPLE 4

Anaerobic Fermentation Using Lactobacillus Paracasei

The fermentation was carried out using the fermentation medium and fermentation conditions referred to under example 2, but using Lb. paracasei.

Lactic acid and diacetyl content after 48 h of fermentation:
L(+)-lactic acid 13.9 g/l; pH 4.0
Diacetyl 2-3.8 ppm

### EXAMPLE 5

Aerobic Fermentation Using Lactobacillus Paracasei

Example 4 was repeated with the provision of aerobic process conditions as described under example 3. After 48 h of fermentation, the following contents were measured:
L(+)-lactic acid 14.5 g/l; pH 4.0
Diacetyl 6.98 ppm

### EXAMPLE 6

Production of Ice Cream

For the ice production, protein preparations according to examples 2 to 5 were used in spray-dried form in addition to a standard preparation (containing milk protein) and an unfermented preparation of plant origin. Various ice cream formulas were studied.

An industrial method for ice cream preparation was used as a basis and adapted accordingly to the laboratory scale.

The ice mix is prepared in a heatable laboratory reactor (IKA), which is provided with a mixer. To obtain a homogeneous structure, a rotor-stator system (Ultra-Turrax) was used. In the first step, the water is charged into the IKA reactor and heated to 95° C. The pulverulent formula constituents are weighed, mixed and metered in with the agitator running (approximately 100 rpm) and also the homogenizer running (IKA 8500 rpm). The oil is then added spontaneously. The temperature is controlled during the entire operation. When the mix has achieved a temperature of 75° C., further pasteurization is performed for 2 minutes.

Then, the system is switched from the heating circuit to the cooling circuit and the mix is cooled to 15° C. with the agitator and homogenizer running. The finished ice mix is packaged and allowed to mature for 24 h at 5° C. so that the aroma components can develop their action. Using an ice machine having an ice pack and agitator, the ice mix is frozen and hardened in a cold room at −20° C. for 24 h. After the expiry of this time the texture, the melting behavior and the sensory properties of the ice cream are characterized.

In a first experimental series the proportion of substituted milk proteins is varied. In this series 0%, 25%, 50% and 100% of the milk proteins were replaced by the protein preparation according to example 2. The starting materials used may be seen in table 1.

TABLE 1
Formulas for the type of ice cream products having
vegetable fat and substitution products:

| | | Milk ice | Plant-based ice cream | | | |
|---|---|---|---|---|---|---|
| Composition No. | | C | 1 | 2 | 3 | 4 |
| Fraction of milk protein | | Reference | 10% | 25% | 50% | 100% |
| replaced | | | | | | |
| Water | ml | 320 | 320 | 320 | 320 | 320 |
| Sugar | g | 62 | 56.5 | 60 | 60 | 62 |
| Glucose syrup dry | g | 23 | 17.5 | 17.5 | 20 | 23 |
| Maltodextrin | g | — | — | — | 5.5 | 15 |
| Vegetable fat | g | 40 | 40 | 40 | 40 | 40 |
| Skimmed milk powder | g | 28 | 39.5 | 34 | 22 | — |
| Whey powder | g | 23.5 | — | — | — | — |
| Protein preparation ex. 2 | g | — | 1.5 | 3.5 | 7.5 | 15 |
| Stabilizer (carrageenan) | g | 3.5 | 3.5 | 3.5 | 3.5 | 3.5 |
| Vanilla sugar | g | 8.5 | 8.5 | 8.5 | 8.5 | 8.5 |
| Sum of constituents | g | 508.5 | 487.0 | 487.0 | 487.0 | 487.0 |

In a second experiment series, four ice creams were produced having the fermented dry products of the individual examples 2 to 5, in which case, in the ice cream formulas, in each case 50% of the milk proteins were replaced by the inventive protein preparation.

In total, eight ice creams were investigated for their sensory behavior, of which one product for comparison was produced without plant proteins and one product was produced using a native unfermented lupine protein isolate according to example 1. Four ice creams originated from the above-mentioned second experiment series in which in each case 50% of the milk proteins had been replaced by protein preparations of the examples 2 to 5. The remaining two ice creams were produced using the compositions 2 and 4 according to table 1 using the dry product according to example 2.

Characterization of the Ice Cream Properties

(A) Sensory Features

Table 2 shows the sensory features of the ice creams produced.

The ice creams produced were rated with respect to shape, appearance, color, odor, flavor and consistency/mouth-feel.

The ice cream 01 (without plant proteins) appears broken on the spoon, edged and grayish-whitish in color. Ice 02 (with protein isolates) is broken in shape on the spoon, but not so edged. The color is yellowish to brownish. Ice creams 03 to 08 are broken in shape, but the color is yellowish to whitish.

Ice creams 01 and 02 differ only slightly in odor. Both products have a mild odor of vanilla and slightly sweet. The odor of the inventive protein preparation gives ice creams 03-08 an aromatic, sour and yogurt-like note.

Ice creams 01 and 02 differ in flavor from one another to the extent that the addition of 50% lupine protein according to example 1 imparts an additional nut-like note to the milk-like taste. Within the ice cream products which were produced using the inventive protein preparation, in the context of the testing, ice 03 was rated as a particularly good-tasting ice cream by all testers. The characteristics milk-like, yogurt-like, vanilla, slightly sour were observed. However, all other ice cream products (03 to 08) also displayed this milk-like flavor profile and a good creaminess.

By using the inventive proteinaceous preparation, as the results described above show, ice creams having “simple ice cream” formulas can be produced which are equivalent, however, in consistency to higher-quality formulas. The consistency features of ice creams 03 to 08 are customarily ascribed to the ice varieties custard ice cream, egg custard ice cream or dairy cream ice cream.

TABLE 2
Sensory properties of the ice cream products

| | Plant | Shape | | | Consis- |
|---|---|---|---|---|---|
| | protein | Appearance | | | tency/ |
| Ice | preparation | Color | Odor | Flavor | mouthfeel |
| 01 | 0% | Broken, | Mild, | Milk-like, | Fatty, |
| | | edged, | vanilla, | sweet, | sticky, |
| | | greenish, | sweet | vanilla, | slimy |
| | | whitish | | floury | |
| | | | | aftertaste | |
| 02 | 50% | Broken, | Mild, | Milk-like, | Less cold |
| | unfermented | yellowish, | sweet, | malty, floury, | than 01, |
| | | brownish | vanilla | nutty, hay- | custard- |
| | | | | like sweet | like, fine, |
| | | | | | light |
| 03 | 50% | As 02 | Aromatic, | Milk-like, | Less cold |
| | preparation | yellowish, | sour, | yogurt-like, | than 01, |
| | according | whitish | vanilla, | vanilla, sour | creamy, |
| | to example | | yogurt- | | custard- |
| | 2 | | like | | like, fine, |
| | | | | | light |
| 04 | 50% | As 03 | As 03 but | As 03 | As 03 |
| | preparation | | less sour | | |
| | according | | | | |
| | to example | | | | |
| | 4 | | | | |
| 05 | 50% | As 03 | As 03 | As 03 | As 03 |
| | preparation | | sweet | | |
| | according | | | | |
| | to example | | | | |
| | 3 | | | | |
| 06 | 50% | As 03 | As 03, | As 03 | As 03 |
| | preparation | | sweet | | |
| | according | | | | |
| | to example | | | | |
| | 4 | | | | |
| 07 | 25% | As 03 | Less | Less intense | As 03 |
| | preparation | | intense | than 03 | |
| | according | | than 03 | | |
| | to example | | | | |
| | 2 | | | | |
| 08 | 100% | As 03 | As 03, | As 03 | As 03, but |
| | preparation | | but more | | firmer, |
| | according | | intense | | tougher |
| | to example | | | | |
| | 2 | | | | |

Texture Properties

Table 3 below shows the strength and melting avior of the ice creams studied.

TABLE 3
Technological properties of the ice cream products

| | | Degree of | | |
|---|---|---|---|---|
| | | substitution | Texture | Melting time |
| Ice | Proteins used | [%] | [N/m²] | [g/min] |
| 01 | Milk proteins | 0 | 2.04 | 0.44 |
| 02 | Unfermented plant | 50 | 3.84 | 0.33 |
| | protein | | | |
| 03 | Protein example 2 | 50 | 4.74 | 0.31 |
| 04 | Protein example 4 | 50 | 4.70 | 0.33 |
| 05 | Protein example 3 | 50 | 4.94 | 0.33 |
| 06 | Protein example 5 | 50 | 4.83 | 0.35 |
| 07 | Protein example 2 | 25 | 3.78 | 0.37 |
| 08 | Protein example 2 | 100 | 4.93 | 0.32 |

Starting from consideration of the Theological ects, replacing the milk proteins by plant proteinaceous parations resulted in improved creaminess, consistency and more pleasant mouthfeel. This is expressed in higher ength of the ice cream products comprising these protein parations which indicated an improved framework and improved structure and distribution of the constituents. A significant effect on the melting behavior may likewise be recognized. The melting rate of the ice products decreases markedly with increasing proportion of lupine protein (see tab. 3).

In the case of variation of the concentration of the inventive protein, it was found that in particular with increasing proportion of plant protein, the creaminess and consistency of the ice product is improved. In the case of the product with 100% replacement of the milk protein, this resulted in a relatively firm structure which, however, was not designated as unpleasant.

As already explained in the previous points, the structure of the ice cream products may be clearly improved by adding plant proteins.

Owing to the generally legume-like flavor, such products, however, are of relatively low interest. Only by the use of the inventive protein preparations may products be obtained which have a milk-like aroma profile. In all tests it was found that the ice produced using the inventive protein preparations was virtually or completely free from legume-like flavor. In particular, the products fermented using Lactobacillus perolens showed a completely clean aroma profile, comparable to the pure milk products.

1. A protein preparation characterized by
at least 60% protein of plant origin, based on the dry weight,
a milk-like aroma which corresponds to an amount of at least 1 ppm of diacetyl, and
a content of lactic acid.

2. The protein preparation as claimed in claim 1, characterized by
at least 70% protein of plant origin, based on the dry weight,
a milk-like aroma which corresponds to an amount of at least 7 ppm of diacetyl, and
a content of at least 0.5% by weight of lactic acid.

3. The protein preparation as claimed in claim 2, characterized by
at least 85% protein of plant origin, based on the dry weight,
a milk-like aroma which corresponds to an amount of at least 15 ppm of diacetyl, and
a content of at least 1.0% by weight of lactic acid.

4. The protein preparation as claimed in claim 1, characterized in that the lactic acid is predominantly or exclusively L-lactic acid.

5. The protein preparation as claimed in claim 1, characterized in that it is lactose-free and cholesterol-free.

6. The protein preparation as claimed in claim 1, characterized in that it comprises probiotic lactic acid bacteria.

7. The protein preparation as claimed in claim 1, characterized in that it is produced using legumes, in particular lupines, soybean and peas, and very particularly preferably lupine seeds.

8. The protein preparation as claimed in claim 1, characterized in that, in 10% strength solution at pH 7, it has an emulsifying activity of 40 to 50%, and/or in that, in 1% strength solution, it can emulsify at least 400 ml, preferably at least 500 ml, of oil/g of protein.

9. The protein preparation as claimed in claim 1, characterized in that, at a pH of 7, it has a foam activity of at least 600%, preferably greater than 950%, and/or a foam density of 190 to 250 g/l.

10. A method for producing a protein preparation, characterized in that plant starting material pretreated in a suitable manner having at least 60% by weight of plant protein, based on the dry weight of the material, is fermented in a manner known per se using a microorganism which produces lactic acid in the presence of one or more nutrient source(s), nitrogen source(s) and/or mineral source(s) necessary for the micro-organism.

11. The method as claimed in claim 10, characterized in that the microorganism is selected from preferably homofermentative and potentially heterofermentative microorganisms, selected from lactococci, lactobacilli and pediococci.

12. The method as claimed in claim 11, characterized in that the microorganism is selected from Lactobacillus perolens, Lactobacillus paracasei and Lactobacillus plantarum.

13. The method as claimed in claim 10, characterized in that the fermentation is carried out using a solution or dispersion of the plant protein in a concentration of 5-25% dry matter, preferably 15 to 20% dry matter.

14. The method as claimed in claim 10, characterized in that the fermentation is performed in a medium to which citric acid has been added in an amount of 0.1 to 2.5 g/l, preferably of about 2 g/l.

15. The method as claimed in claim 10, characterized in that the fermentation is performed in the presence of a buffer which buffers the fall in pH due to the formation of lactic acid.

16. The protein preparation as claimed in claim 1, wherein the milk-like aroma was obtained by the biotechnological treatment of a predominantly or exclusively plant starting material.

17. The protein preparation as claimed in claim 1 obtained by a method for producing a protein preparation, characterized in that plant starting material pretreated in a suitable manner having at least 60% by weight of plant protein, based on the dry weight of the material, is fermented in a manner known per se using a microorganism which produces lactic acid in the presence of one or more nutrient source(s), nitrogen source(s) and/or mineral source(s) necessary for the micro-organism.

18. The use of a protein preparation as claimed in claim 1 as food ingredient.

19. The use of a protein preparation as claimed in claim 6 as probiotic food.

20. The use of a protein preparation as claimed in claim 18 for producing ice cream.
